(19) United States
(12) Patent Application Publication
(10) Pub. No.: US 2022/0404295 A1
(43) Pub. Date: Dec. 22, 2022

(54) X-RAY COMPUTED TOMOGRAPHY APPARATUS AND IMAGE GENERATION METHOD

(71) Applicant: TOYOTA JIDOSHA KABUSHIKI KAISHA, Toyota-shi (JP)

(72) Inventor: Akihiro TOYODA, Nagakute-shi (JP)

(73) Assignee: TOYOTA JIDOSHA KABUSHIKI KAISHA, Toyota-shi (JP)

(21) Appl. No.: 17/805,313

(22) Filed: Jun. 3, 2022

(30) Foreign Application Priority Data
Jun. 16, 2021 (JP) 2021-100036

(51) Int. Cl. G01N 23/046; G01N 23/223; G01N 23/083

(52) U.S. Cl. CPC G01N 23/046; G01N 23/223; G01N 23/083; G01N 2223/401; G01N 2223/045

(57) ABSTRACT

An X-ray computed tomography apparatus images a subject while relatively rotating an X-ray source and an X-ray detector, and the subject. The X-ray computed tomography apparatus includes a theoretical image calculation unit that calculates a theoretical image obtained by irradiating a test object for calibration with X-rays using a geometrical parameter indicating a positional relationship between the X-ray source and the X-ray detector, a correction amount calculation unit that calculates a correction amount based on an amount of deviation between the theoretical image of the test object for calibration and a fluoroscopic image obtained by irradiating the test object for calibration with X-rays, and an image correction unit that corrects a fluoroscopic image of the subject using the correction amount.

### CROSS-REFERENCE TO RELATED APPLICATION

This application claims priority to Japanese Patent Application No. 2021-100036 filed on Jun. 16, 2021, incorporated herein by reference in its entirety.

### BACKGROUND

### 1. Technical Field

The present disclosure relates to an X-ray computed tomography apparatus and an image generation method.

### 2. Description of Related Art

In recent years, an X-ray computed tomography apparatus for measurement is used for inspection of a defect of a component, failure of welding, or the like that is hardly confirmed through an appearance. Since the X-ray computed tomography apparatus is requested to have high measurement accuracy, accurate calibration counts for much. The calibration of basic characteristics of the X-ray computed tomography apparatus is performed using various parameters from an image obtained by imaging a test object for calibration.

Japanese Unexamined Patent Application Publication No. 9-173330 (JP 9-173330 A) discloses a technique that corrects an image of a subject by calculating, from an image obtained by imaging a test object for calibration using rotation means, a rotation center position and a rotation angle on the image and creating a correction table in advance in an X-ray computed tomography apparatus.

### SUMMARY

In the X-ray computed tomography apparatus disclosed in JP 9-173330 A, since “shake” during rotation of a rotation axis of the rotation means is not taken into account, a measurement error remains due to “shake”, and the calibration may not be performed with excellent accuracy. For this reason, the X-ray computed tomography apparatus disclosed in JP 9-173330 A hardly performs the calibration of the rotation means with excellent accuracy by a general motor not having accuracy when assuming utilization for X-ray computed tomography in an industrial robot or the like.

An aspect of the disclosure provides an X-ray computed tomography apparatus and an image generation method that enable measurement with high accuracy even though general-purpose rotation means, such as an industrial robot, using a general motor or the like is used.

A first aspect of the disclosure relates to an X-ray computed tomography apparatus including a table on which a subject is placed, an X-ray source, an X-ray detector, and a fluoroscopic image generation unit. The X-ray source is configured to irradiate the subject with X-rays. The X-ray detector is configured to detect X-rays transmitted through the subject. The fluoroscopic image generation unit is configured to generate a fluoroscopic image of the subject based on an X-ray dose detected by the X-ray detector. The X-ray computed tomography apparatus is configured to image the subject while relatively rotating the X-ray source and the X-ray detector, and the subject. The X-ray computed tomography apparatus includes a theoretical image calculation unit, a correction amount calculation unit, and an image correction unit. The theoretical image calculation unit is configured to calculate a theoretical image obtained by irradiating a test object for calibration with X-rays using a geometrical parameter indicating a positional relationship between the X-ray source and the X-ray detector. The correction amount calculation unit is configured to calculate a correction amount based on an amount of deviation between the theoretical image of the test object for calibration and a fluoroscopic image obtained by irradiating the test object for calibration with X-rays. The image correction unit is configured to correct the fluoroscopic image of the subject using the correction amount.

In the first aspect of the disclosure, the X-ray computed tomography apparatus may further include a gripping device configured to grip the X-ray source and the X-ray detector, and a controller configured to control at least one of an operation of the gripping device and a rotation operation of the table.

In the first aspect of the disclosure, the X-ray computed tomography apparatus may further include a three-dimensional image generation unit configured to generate a three-dimensional image of the subject based on the fluoroscopic image of the subject corrected using the correction amount.

A second aspect of the disclosure relates to an image generation method using an X-ray computed tomography apparatus configured to image a subject while relatively rotating an X-ray source and an X-ray detector, and the subject. The image generation method includes irradiating the subject placed on a table with X-rays from the X-ray source, detecting X-rays transmitted through the subject by the X-ray detector, and generating a fluoroscopic image of the subject based on an X-ray dose detected by the X-ray detector. Before imaging of the subject, in performing calibration of the X-ray computed tomography apparatus using a test object for calibration, a theoretical image obtained by irradiating the test object for calibration with X-rays is calculated using a geometrical parameter indicating a positional relationship between the X-ray source and the X-ray detector, a correction amount is calculated based on an amount of deviation between the theoretical image of the test object for calibration and a fluoroscopic image obtained by irradiating the test object for calibration with X-rays, and the fluoroscopic image of the subject is corrected using the correction amount.

According to the aspects of the disclosure, it is possible to provide an X-ray computed tomography apparatus and an image generation method that enable measurement with high accuracy even though general-purpose rotation means, such as an industrial robot, using a general motor or the like is used.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram of an X-ray computed tomography apparatus according to Embodiment 1 of the disclosure;

FIG. 2 is a diagram showing an image of an X-ray fluoroscopic image of a subject in an X-ray computed tomography apparatus according to Embodiment 2 of the disclosure;

FIG. 3 is a diagram showing an image of an imaging system and an X-ray fluoroscopic image when “shake” at a distance L occurs in a rotation axis with respect to a center axis of a test object for calibration in a direction perpendicular to an irradiation direction of X-rays in the X-ray computed tomography apparatus according to Embodiment 2 of the disclosure;

FIG. 4 is a diagram showing an image of an imaging system and an X-ray fluoroscopic image when “shake” at an angle θ occurs in the rotation axis with respect to the center axis of the test object for calibration on a plane perpendicular to the irradiation direction of the X-rays in the X-ray computed tomography apparatus according to Embodiment 2 of the disclosure;

FIG. 5 is a diagram showing an image of an imaging system and an X-ray fluoroscopic image when “shake” at an angle θ occurs in the rotation axis with respect to the center axis of the test object for calibration in the X-ray irradiation direction in the X-ray computed tomography apparatus according to Embodiment 2 of the disclosure;

FIG. 6 is a configuration diagram of the X-ray computed tomography apparatus according to Embodiment 2 of the disclosure;

FIG. 7 is a configuration diagram of an X-ray computed tomography apparatus according to a modification example of Embodiment 2 of the disclosure;

FIG. 8 is a configuration diagram of an X-ray computed tomography apparatus according to Embodiment 3 of the disclosure; and

FIG. 9 is a configuration diagram of an X-ray computed tomography apparatus according to a modification example of Embodiment 3 of the disclosure.

### DETAILED DESCRIPTION OF EMBODIMENTS

Hereinafter, embodiments will be described referring to the drawings. Note that, since the drawings are drawn in a simplified manner, the technical scope of the embodiments should not be narrowly interpreted based on the description of the drawings. The same elements are represented by the same reference numerals and redundant description will not be repeated.

### Embodiment 1

Configuration of X-Ray Computed Tomography Apparatus 1

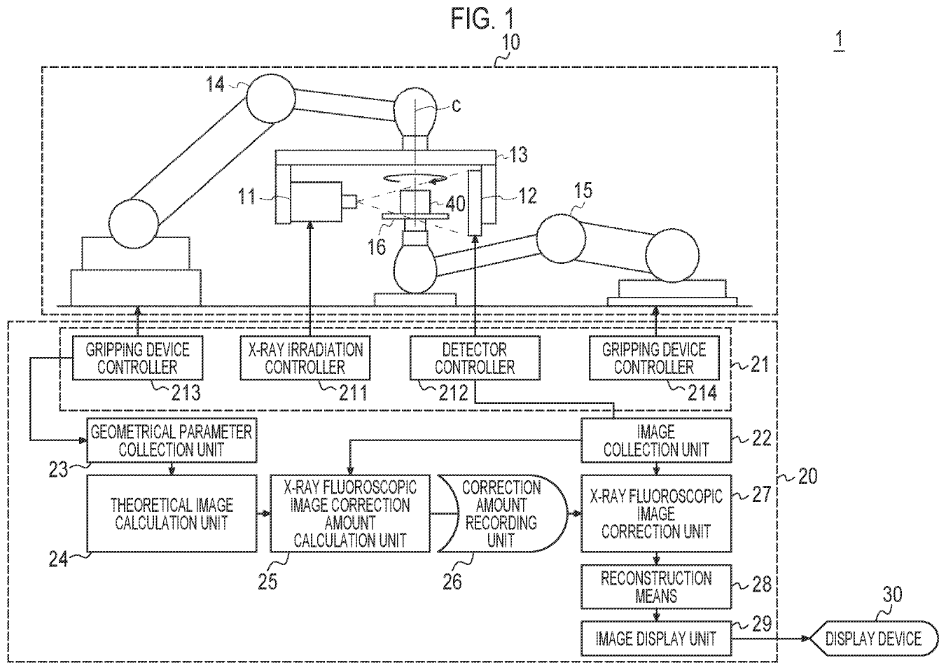

The configuration of an X-ray computed tomography apparatus 1 in the embodiment will be described referring to FIG. 1. FIG. 1 is a configuration diagram of the X-ray computed tomography apparatus 1 according to the embodiment. The X-ray computed tomography apparatus 1 includes an imaging unit 10, a control arithmetic unit 20, and a display device 30. The X-ray computed tomography apparatus 1 images a subject while relatively rotating the subject including a test object 40 for calibration and an imaging system configured to image the subject. In the embodiment, the X-ray computed tomography apparatus 1 performs imaging in a state in which a gripping device 15 that places and rotates the test object 40 for calibration on a table 16 grips the test object 40 for calibration. Hereinafter, although each constituent element of the X-ray computed tomography apparatus 1 will be described assuming that the test object 40 for calibration is imaged, the same operation is to be performed when a subject other than the test object 40 for calibration is imaged.

The test object 40 for calibration is formed using a material having limited X-ray transmittance. The test object 40 for calibration may include positioning means for disposition in such a manner that a rotation axis c of the table 16 and a center axis of the test object 40 for calibration coincide with each other. The test object 40 for calibration may have a known shape capable of specifying upper, lower, right, and left positions, an angle, and an enlargement ratio on an X-ray fluoroscopic image. The test object 40 for calibration shown in the drawing is formed of a material having a large X-ray absorption coefficient cut in a round bar shape and has a stepped the diameter of which changes. Alternatively, the test object 40 for calibration may have a shape in which a spherical material having a known diameter and a large X-ray absorption coefficient is linearly disposed at known internals, but may not be limited to such shapes and may have various shapes.

The imaging unit 10 includes an X-ray source 11, an X-ray detector 12, a bracket 13, a gripping device 14, the gripping device 15, and the table 16. The control arithmetic unit 20 includes imaging unit controller 21, image collection unit 22, geometrical parameter collection unit 23, theoretical image calculation unit 24, X-ray fluoroscopic image correction amount calculation unit 25, correction amount recording unit 26, X-ray fluoroscopic image correction unit 27, reconstruction means 28 (three-dimensional image generation unit), and image display unit 29.

The imaging unit 10 acquires an X-ray fluoroscopic image of the test object 40 for calibration using the X-ray source 11 and the X-ray detector 12 as an imaging system. The control arithmetic unit 20 controls the elements of the imaging unit 10, corrects the acquired X-ray fluoroscopic image of the test object 40 for calibration, and generates a three-dimensional image (3D image) based on the X-ray fluoroscopic image after correction. The display device 30 displays the 3D image of the test object 40 for calibration. The X-ray computed tomography apparatus 1 may be a cone beam X-ray computed tomography apparatus, but is not limited thereto and may be various X-ray computed tomography apparatuses, such as a helical computed tomography apparatus.

The X-ray source 11 irradiates the test object 40 for calibration with X-rays. The X-ray detector 12 detects X-rays transmitted through the test object 40 for calibration. The X-ray detector 12 outputs the acquired X-ray fluoroscopic image of the test object 40 for calibration to the control arithmetic unit 20. The X-ray detector 12 is a flat panel detector that acquires a two-dimensional image as the X-ray fluoroscopic image of the test object 40 for calibration. Alternatively, the X-ray detector 12 may be a combination of an image intensifier converting an X-ray fluoroscopic image into a visible light image and a visible light sensor, such as a CMOS sensor, or an X-ray line sensor that obtains a one-dimensional image, and various forms can be used.

The bracket 13 couples the X-ray source 11 and the X-ray detector 12. The gripping device 14 grips the X-ray source 11 and the X-ray detector 12 through the bracket 13 and adjusts a position of the imaging system (X-ray source 11 and the X-ray detector 12) with respect to the test object 40 for calibration. The gripping device 15 grips the test object 40 for calibration. In an example shown in FIG. 1, the test object 40 for calibration is gripped gripping device 15 through the table 16. The gripping device 15 grips the table 16 and the test object 40 for calibration and rotates the table 16 and the test object 40 for calibration around a rotation axis c to enable acquisition of an X-ray fluoroscopic image from a plurality of imaging directions. The X-ray computed tomography apparatus 1 can automatically execute imaging of a lot of subjects by adding an automatic picking function to the gripping device 15.

The disposition and posture of the gripping devices 14, 15 are controlled by the control arithmetic unit 20. Relative positions and rotation angles of the rotation axis c and the imaging system (X-ray source 11 and X-ray detector 12) are output as geometrical parameters for use in generating a 3D image of the test object 40 for calibration. That is, the geometrical parameters are parameters indicating a positional relationship between the imaging system (X-ray source 11 and X-ray detector 12) and the test object 40 for calibration. For example, the geometrical parameters are a position of the X-ray source 11 and a position of the X-ray detector 12 based on the rotation axis c. More specifically, the geometrical parameters are parameters indicating a relative position of each element of the imaging unit 10, and are, for example, the position and angle of the X-ray source 11 and the position and angle of the X-ray detector 12 based on the rotation axis c. A focal position or the like of X-rays can be calculated based on the geometrical parameters. Actually, the relative position of each element of the imaging unit 10, that is, the geometrical parameters include installation errors with respect to design values. Note that the errors can be measured using known three-dimensional measuring equipment or the like and the geometrical parameter can be corrected before calibration is performed.

The imaging unit controller 21 controls each element of the imaging unit 10. The imaging unit controller 21 includes X-ray irradiation controller 211, detector controller 212, and gripping device controller 213, 214. The X-ray irradiation controller 211 controls output conditions of X-rays, such as irradiation power as transmission power of X-rays or an irradiation dose. The X-ray irradiation controller 211 controls on and off of X-rays to irradiate. The detector controller 212 controls acquisition conditions indicating an exposure time of X-rays that are detected by the X-ray detector 12, and the like. The gripping device controller 213, 214 controls the operations of the gripping devices 14, 15, respectively.

The image collection unit 22 collects and stores the X-ray fluoroscopic image generated by and output from the X-ray detector 12 and the detector controller 212. The geometrical parameter collection unit 23 collects and stores the geometrical parameters of the imaging system in each imaging posture and direction. The theoretical image calculation unit 24 calculates a theoretical image of the test object 40 for calibration using the geometrical parameters indicating the positional relationship of the imaging system. The theoretical image can be theoretically calculated from the geometrical parameter and the shape of the test object 40 for calibration. That is, the theoretical image is an image having a theoretical dimension obtained by irradiating the test object 40 for calibration with X-rays.

The X-ray fluoroscopic image correction amount calculation unit 25 calculates a correction amount based on an amount of deviation between the theoretical image of the test object 40 for calibration in theory and the X-ray fluoroscopic image of the test object 40 for calibration. The amount of deviation includes an amount of positional deviation of the test object 40 for calibration and a deviation angle of the test object 40 for calibration with respect to the rotation axis in the X-ray fluoroscopic image. The imaged test object 40 for calibration can be corrected to an image based on the theoretical image using the geometrical parameters. Note that a deviation of the test object 40 for calibration in the X-ray fluoroscopic image due to “shake” of the rotation axis c cannot be corrected. Accordingly, the deviation of the test object 40 for calibration in the X-ray fluoroscopic image can be corrected using the correction amount calculated by the X-ray fluoroscopic image correction amount calculation unit 25.

The correction amount recording unit 26 records the correction amount of the X-ray fluoroscopic image calculated by the X-ray fluoroscopic image correction amount calculation unit 25. The X-ray fluoroscopic image correction unit 27 corrects the X-ray fluoroscopic image of the test object 40 for calibration using the correction amount. Even though the X-ray fluoroscopic image correction unit 27 corrects the X-ray fluoroscopic image of the test object 40 for calibration using the correction amount, the X-ray fluoroscopic image may completely coincide with the theoretical image. For this reason, the X-ray fluoroscopic image correction unit 27 may perform adjustment to improve unsharpness of the X-ray fluoroscopic image of the test object 40 for calibration using a method, such as binning. The reconstruction means 28 generates a 3D image of the subject based on the X-ray fluoroscopic image of the test object 40 for calibration corrected using the correction amount. The image display unit 29 displays the 3D image of the test object 40 for calibration on the display device 30.

Since a rotation axis in general-purpose rotation means, such as an industrial robot, using a general motor or the like does not take “shake” into account, a measurement error remains due to “shake”, and calibration may not be performed with excellent accuracy. In contrast, the X-ray computed tomography apparatus 1 in the embodiment can perform calibration with excellent accuracy even when general-purpose rotation means using a general motor is used. In the X-ray computed tomography apparatus 1 in the embodiment, the theoretical image of the test object 40 for calibration calculated based on the geometrical parameters is obtained. Then, the theoretical image of the test object 40 for calibration and the actually obtained X-ray fluoroscopic image of the test object 40 for calibration are compared, and correction amounts of an angle and a magnification of the X-ray fluoroscopic image are calculated such that the X-ray fluoroscopic image coincides with the theoretical image.

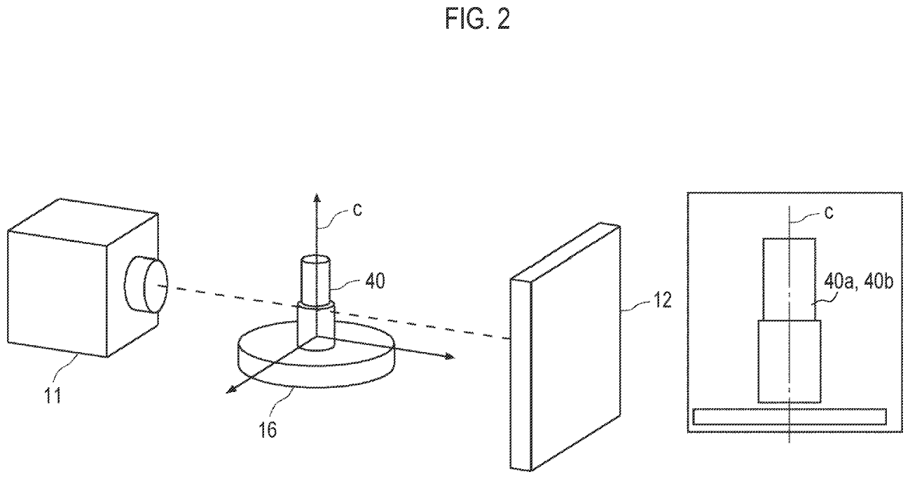

Here, correction of the X-ray fluoroscopic image of the test object 40 for calibration with respect to “shake” of the rotation axis c will be described referring to FIGS. 2 to 5. As shown in FIGS. 2 to 5, the test object 40 for calibration is placed on the table 16, and X-rays emitted from the X-ray source 11 are transmitted through the test object 40 for calibration and detected in the X-ray detector 12. A broken line in an X-ray fluoroscopic image shown in FIGS. 2 to 5 indicates a theoretical image 40a of the test object 40 for calibration, and a solid line indicates a fluoroscopic image 40b obtained by irradiating the test object 40 for calibration with X-rays.

In FIG. 2, the rod-shaped test object 40 for calibration rotating around the rotation axis c is imaged, and the center axis of the test object 40 for calibration and the rotation axis c are disposed to coincide with each other. FIG. 2 is an image of the imaging system and an X-ray fluoroscopic image when the test object 40 for calibration is imaged in a state in which there is no “shake” in the rotation axis c. For this reason, the theoretical image 40a of the test object 40 for calibration and the fluoroscopic image 40b obtained by irradiating the test object 40 for calibration with X-rays coincide with each other.

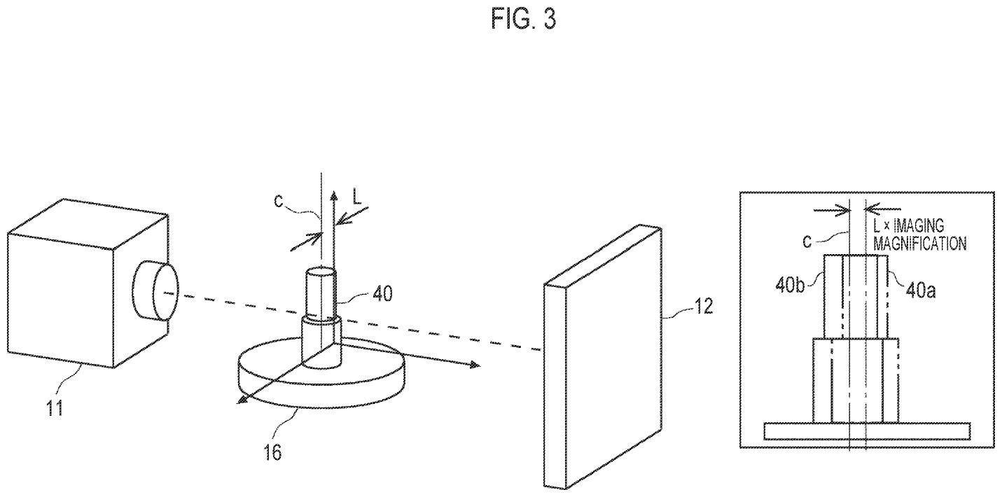

FIG. 3 is an image of the imaging system and an X-ray fluoroscopic image when “shake” at a distance L occurs in the rotation axis X with respect to the center axis of the test object 40 for calibration in a direction perpendicular to an irradiation direction of X-rays. For this reason, the theoretical image 40a and the fluoroscopic image 40b of the test object 40 for calibration have a positional deviation corresponding to the distance L×an imaging magnification. For this reason, the fluoroscopic image 40b is corrected by moving the fluoroscopic image 40b toward the rotation axis c with a correction amount corresponding to the distance L×the imaging magnification.

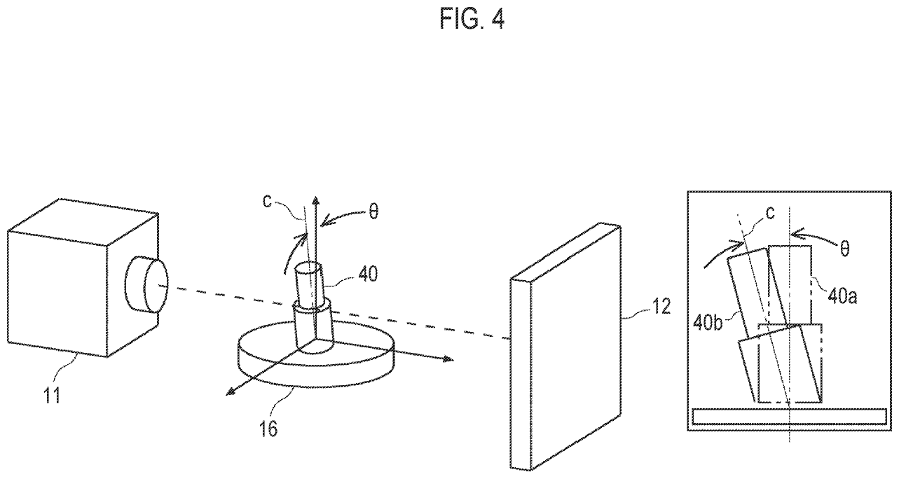

FIG. 4 is an image of the imaging system and an X-ray fluoroscopic image when “shake” at an angle θ occurs in the rotation axis c with respect to the center axis of the test object 40 for calibration on a plane perpendicular to the irradiation direction of X-rays. For this reason, the theoretical image 40a and the fluoroscopic image 40b of the test object 40 for calibration have an angular deviation corresponding to the angle θ with respect to the rotation axis c. For this reason, the fluoroscopic image 40b is corrected by rotating the fluoroscopic image 40b with a correction amount corresponding to the angle θ based on the rotation axis c.

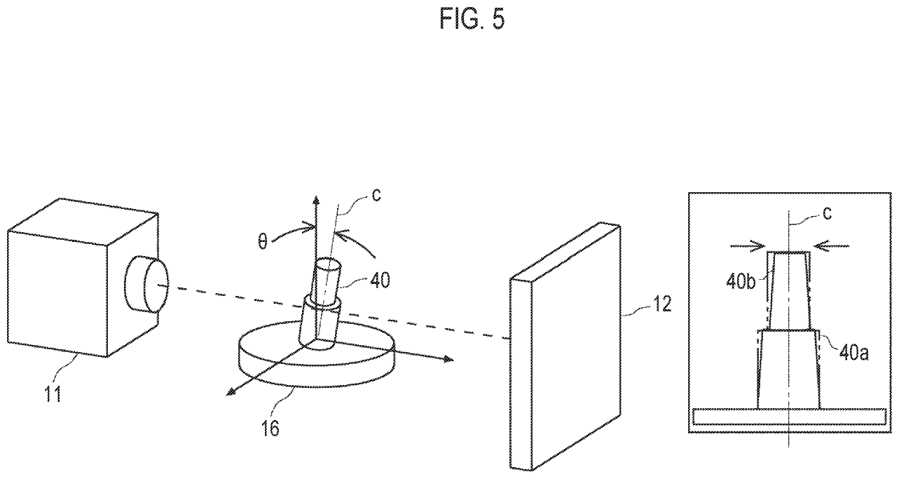

FIG. 5 is an image of the imaging system and an X-ray fluoroscopic image when “shake” at an angle θ occurs in the rotation axis c with respect to the center axis of the test object 40 for calibration in the X-ray irradiation direction. For this reason, since the theoretical image 40a and the fluoroscopic image 40b of the test object 40 for calibration are different in magnification on upper and lower sides of the image, a correction amount is calculated for each scanning line in a horizontal direction of the fluoroscopic image 40b, and correction is performed through enlargement or reduction.

As described above, the X-ray computed tomography apparatus 1 in the embodiment can correct “shake” of the rotation axis c based on the correction amount calculated using the theoretical image and the fluoroscopic image of the test object 40 for calibration. For this reason, with the X-ray computed tomography apparatus 1 in the embodiment, it is possible to perform measurement with high accuracy even when general-purpose rotation means, such as a robot for work, using a motor is used.

Image Generation Method

Next, an image generation method using the X-ray computed tomography apparatus 1 in the embodiment will be described referring to FIG. 1.

First, the operation of the X-ray computed tomography apparatus 1 in imaging the subject will be described.

First, the X-ray source 11 irradiates the subject placed on the table 16 with X-rays.

Then, the X-ray detector 12 detects X-rays transmitted through the subject and generates a fluoroscopic image of the subject based on a detected X-ray dose. Imaging of the subject is performed while relatively rotating the X-ray source 11 and the X-ray detector 12, and the subject.

Next, the calibration that is performed before the subject is imaged will be described. The calibration is performed using the test object 40 for calibration.

First, the geometrical parameter collection unit 23 collects the geometrical parameters indicating the positional relationship between the X-ray source 11 and the X-ray detector 12.

Next, the theoretical image calculation unit 24 calculates a theoretical image obtained by irradiating the test object 40 for calibration with X-rays using the geometrical parameters.

Then, the X-ray fluoroscopic image correction amount calculation unit 25 calculates a correction amount to be applied to the fluoroscopic image based on an amount of deviation between the theoretical image of the test object 40 for calibration and a fluoroscopic image obtained by irradiating the test object 40 for calibration with X-rays. In imaging the subject, the X-ray fluoroscopic image correction unit 27 corrects the fluoroscopic image of the subject using the correction amount calculated by the X-ray fluoroscopic image correction amount calculation unit 25.

### Embodiment 2

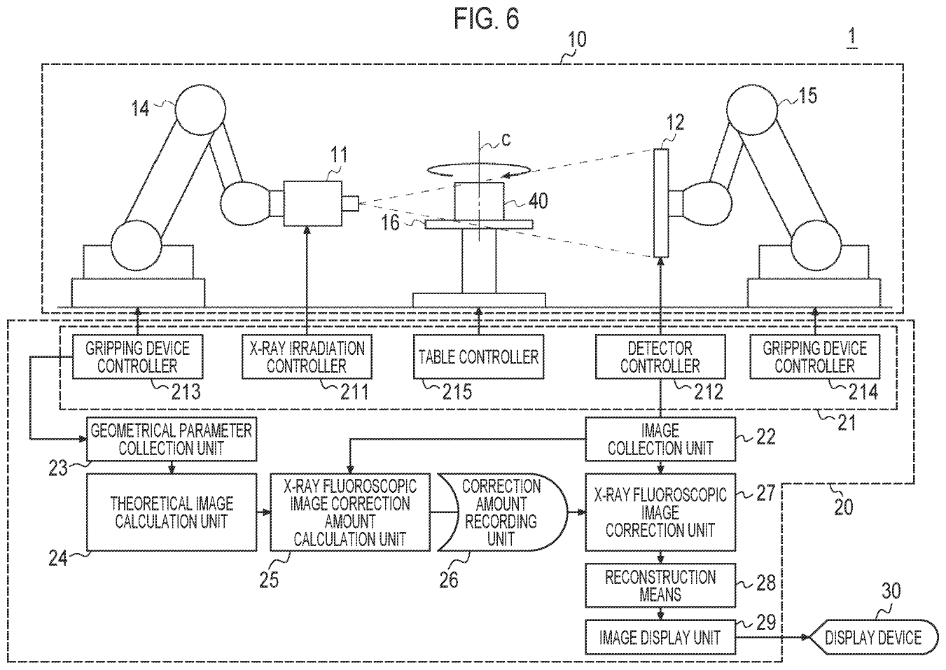

The configuration of an X-ray computed tomography apparatus 1 in the embodiment will be described referring to FIG. 6. FIG. 6 is a configuration diagram of the X-ray computed tomography apparatus 1 according to the embodiment. The X-ray computed tomography apparatus 1 includes an imaging unit 10, a control arithmetic unit 20, and a display device 30. The imaging unit 10 includes an X-ray source 11, an X-ray detector 12, a gripping device 14, a gripping device 15, and a table 16. The control arithmetic unit 20 includes imaging unit controller 21, image collection unit 22, geometrical parameter collection unit 23, theoretical image calculation unit 24, X-ray fluoroscopic image correction amount calculation unit 25, correction amount recording unit 26, X-ray fluoroscopic image correction unit 27, reconstruction means 28, and image display unit 29.

A difference from the X-ray computed tomography apparatus 1 in Embodiment 1 is that the test object 40 for calibration is placed and imaged on the table 16 without using the bracket 13. The gripping device 14 grips the X-ray source 11 and adjusts the position of the X-ray source 11 with respect to the test object 40 for calibration. The gripping device 15 grips the X-ray detector 12 and adjusts the position of the X-ray detector 12 with respect to the test object 40 for calibration. The gripping device controller 213, 214 controls the operations of the gripping devices 14, 15, respectively.

The imaging unit controller 21 includes table controller 215. The table controller 215 controls a rotation operation of the table 16 on which the test object 40 for calibration is placed. The table 16 performs rotational movement at 360 degrees along the rotation axis c. The table 16 has the test object 40 for calibration placed thereon and rotates around the rotation axis c to enable acquisition of an X-ray fluoroscopic image from a plurality of imaging directions.

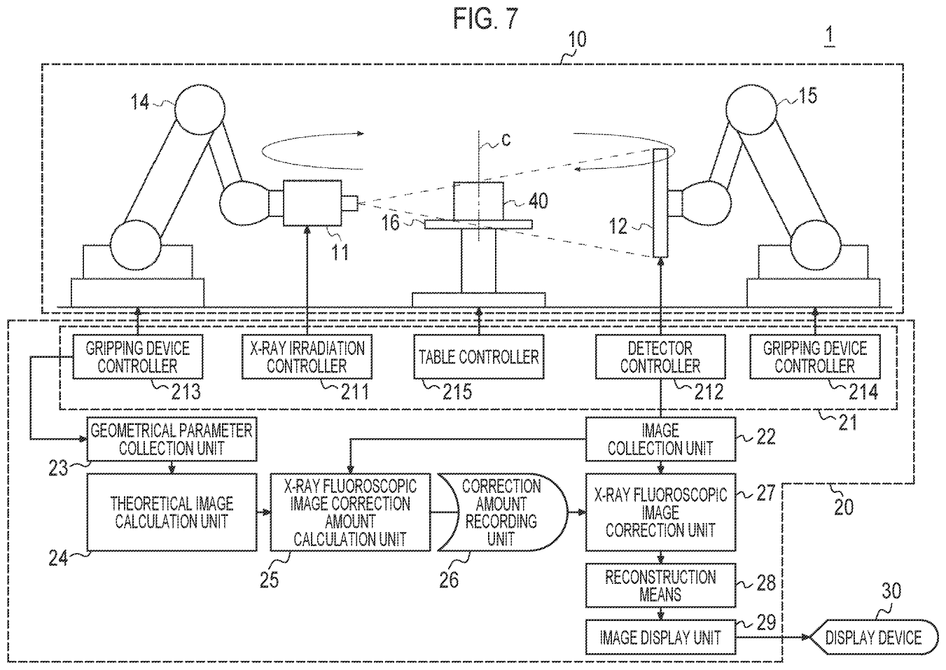

FIG. 7 shows a modification example of the X-ray computed tomography apparatus 1 in the embodiment. As shown in FIG. 7, the table 16 may not be rotated, and the X-ray source 11 and the X-ray detector 12 may rotate with a center axis of the table 16 as a rotation axis. The gripping device controller 213, 214 rotate the X-ray source 11 and the X-ray detector 12, respectively.

With the X-ray computed tomography apparatus 1 in the embodiment, since the bracket 13 is not used, a degree of freedom for installation positions of X-ray source 11 and the X-ray detector 12 increases, and restrictions to the size and the shape of the imageable test object 40 for calibration are relaxed.

### Embodiment 3

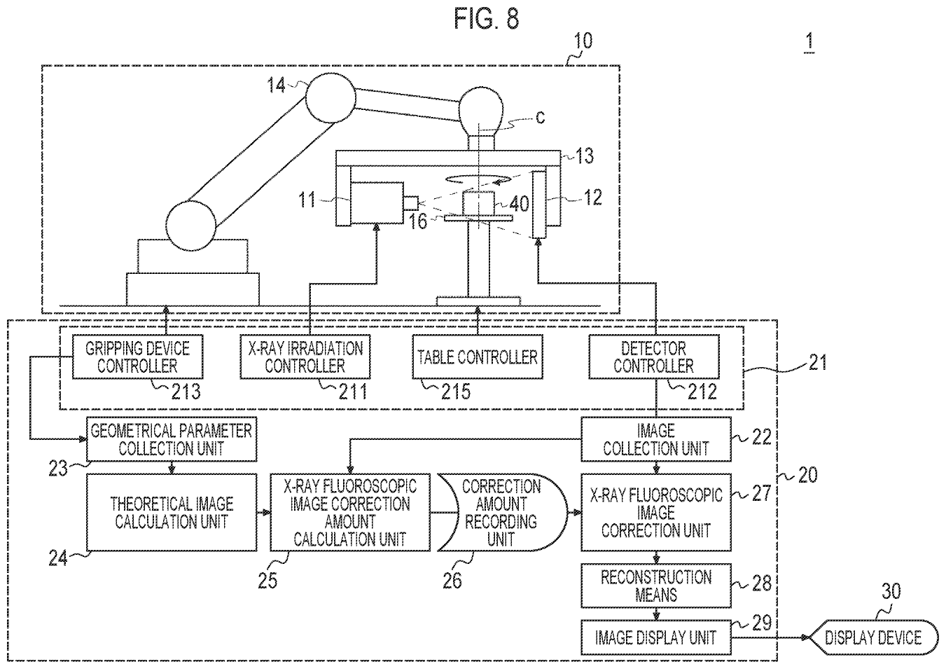

The configuration of an X-ray computed tomography apparatus 1 in the embodiment will be described referring to FIG. 8. FIG. 8 is a configuration diagram of the X-ray computed tomography apparatus 1 according to the embodiment. The X-ray computed tomography apparatus 1 includes an imaging unit 10, a control arithmetic unit 20, and a display device 30. The imaging unit 10 includes an X-ray source 11, an X-ray detector 12, a bracket 13, a gripping device 14, and a table 16. The control arithmetic unit 20 includes imaging unit controller 21, image collection unit 22, geometrical parameter collection unit 23, theoretical image calculation unit 24, X-ray fluoroscopic image correction amount calculation unit 25, correction amount recording unit 26, X-ray fluoroscopic image correction unit 27, reconstruction means 28, and image display unit 29.

A difference from the X-ray computed tomography apparatus 1 in Embodiment 2 is that the bracket 13 is used and the gripping device 15 is not used. The gripping device 14 grips the X-ray source 11 and the X-ray detector 12 through the bracket 13 and adjusts a position of the imaging system (X-ray source 11 and the X-ray detector 12) with respect to the test object 40 for calibration. As shown in FIG. 8, a table controller 215 controls the rotation of the table 16. The table 16 has the test object 40 for calibration placed thereon and rotates around the rotation axis c to enable acquisition of an X-ray fluoroscopic image from a plurality of imaging directions.

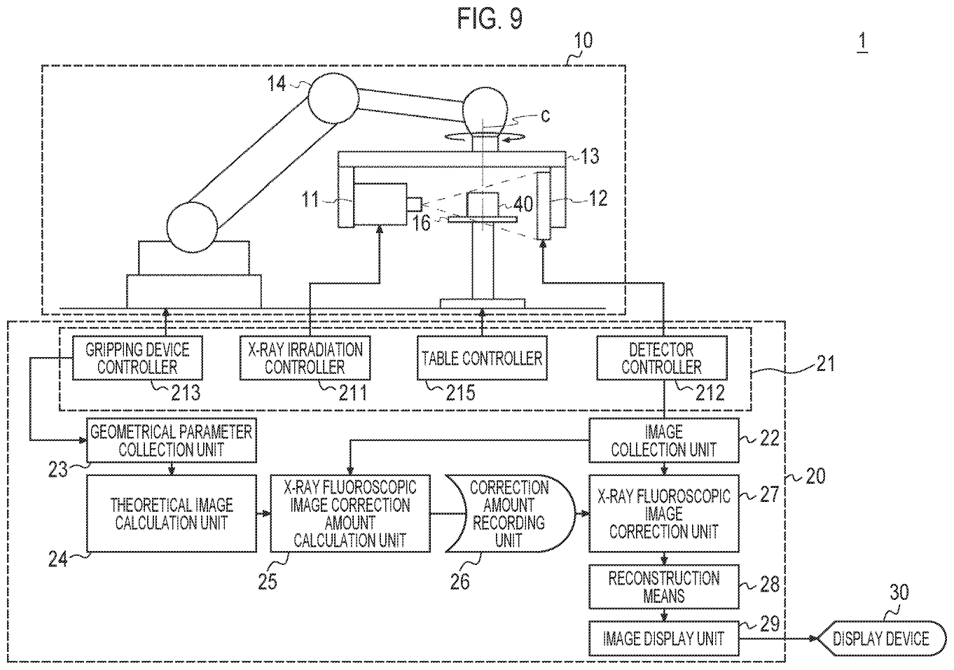

FIG. 9 shows a modification example of the X-ray computed tomography apparatus 1 in the embodiment. As shown in FIG. 9, the table 16 may not be rotated, and the X-ray source 11 and the X-ray detector 12 may be rotated with the center axis of the table 16 as a rotation axis. The gripping device controller 213 rotates the X-ray source 11 and the X-ray detector 12 through the gripping device 14 individually.

With the X-ray computed tomography apparatus 1 in the embodiment, since the gripping device is made compact, and the control of the table 16 is not needed, the control of the entire apparatus is simplified.

In the above-described example, the program includes a set of instructions (or software code), when loaded into a computer, to cause the computer to perform one or more functions described in the embodiments. The program may be stored in a non-transitory computer readable medium or a tangible storage medium. As a non-limiting example, the computer readable medium or the tangible storage medium includes a random-access memory (RAM), a read-only memory (ROM), a flash memory, a solid-state drive (SSD), or other memory techniques, a CD-ROM, a digital versatile disc (DVD), a Blu-ray (Registered Trademark) disc, or other optical disc storages, and a magnetic cassette, a magnetic tape, a magnetic disk storage, and other magnetic storage devices. The program may be transmitted on a transitory computer readable medium or a communication medium. As a non-limiting example, the transitory computer readable medium or the communication medium includes electrical, optical, acoustic, or other formats of propagation signals.

Note that the disclosure is not limited to the above-described embodiments, and can be appropriately changed without departing from the spirit and scope of the disclosure.

What is claimed is:

1. An X-ray computed tomography apparatus including a table on which a subject is placed, an X-ray source configured to irradiate the subject with X-rays, an X-ray detector configured to detect X-rays transmitted through the subject, and a fluoroscopic image generation unit configured to generate a fluoroscopic image of the subject based on an X-ray dose detected by the X-ray detector, and the X-ray computed tomography apparatus being configured to image the subject while relatively rotating the X-ray source and the X-ray detector, and the subject, the X-ray computed tomography apparatus comprising:
a theoretical image calculation unit configured to calculate a theoretical image obtained by irradiating a test object for calibration with X-rays using a geometrical parameter indicating a positional relationship between the X-ray source and the X-ray detector;
a correction amount calculation unit configured to calculate a correction amount based on an amount of deviation between the theoretical image of the test object for calibration and a fluoroscopic image obtained by irradiating the test object for calibration with X-rays; and
an image correction unit configured to correct the fluoroscopic image of the subject using the correction amount.

2. The X-ray computed tomography apparatus according to claim 1, further comprising:
a gripping device configured to grip the X-ray source and the X-ray detector; and
a controller configured to control at least one of an operation of the gripping device and a rotation operation of the table.

3. The X-ray computed tomography apparatus according to claim 1, further comprising a three-dimensional image generation unit configured to generate a three-dimensional image of the subject based on the fluoroscopic image of the subject corrected using the correction amount.

4. An image generation method using an X-ray computed tomography apparatus that images a subject while relatively rotating an X-ray source and an X-ray detector, and the subject, the image generation method comprising:
irradiating the subject placed on a table with X-rays from the X-ray source;
detecting X-rays transmitted through the subject by the X-ray detector; and
generating a fluoroscopic image of the subject based on an X-ray dose detected by the X-ray detector, wherein:
before imaging of the subject, in performing calibration of the X-ray computed tomography apparatus using a test object for calibration, a theoretical image obtained by irradiating the test object for calibration with X-rays is calculated using a geometrical parameter indicating a positional relationship between the X-ray source and the X-ray detector;
a correction amount is calculated based on an amount of deviation between the theoretical image of the test object for calibration and a fluoroscopic image obtained by irradiating the test object for calibration with X-rays; and
the fluoroscopic image of the subject is corrected using the correction amount.
